(19) United States
(12) Patent Application Publication
(10) Pub. No.: US 2009/0207009 A1
(43) Pub. Date: Aug. 20, 2009

(54) Method and Device for Monitoring Pressure of Vehicle Tires

(75) Inventors: Wolfgang Kiesewetter, Altdorf (DE); Jan Kipping, Stuttgart (DE); Frank Schlosser, Weissach (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 11/884,733

(22) PCT Filed: Feb. 4, 2006
(86) PCT No.: PCT/EP2006/000984

§ 371 Date: Sep. 8, 2008

(30) Foreign Application Priority Data
Feb. 22, 2005 (DE) 10 2005 008 023.5

(51) Int. Cl. B60C 23/02

(52) U.S. Cl. 340/442

(57) ABSTRACT

In a method and apparatus for monitoring vehicle tire the pressure a tire inflation pressure is determined and compared with at least one stored set point value. Based on the comparison result, it is determined whether the vehicle tire has an incorrect tire pressure, particularly an excessively low tire pressure. A first warning message is activated if the determined incorrect tire pressure reaches or exceeds a predefined first threshold value. According to the invention, output of the first warning message is delayed until after the ignition has been switched off for a predefinable time period.

This application is a national stage of PCT International Application No. PCT/EP2006/000984, filed Feb. 4, 2006, which claims priority under 35 U.S.C. § 119 to German Patent Application No. 10 2005 008 023.5, filed Feb. 22, 2007, the disclosure(s) of which is (are) expressly incorporated by reference herein.

### BACKGROUND AND SUMMARY OF THE INVENTION

The invention relates to a method for monitoring the pressure of vehicle tires by comparing measured tire pressure with stored setpoint values.

Various devices and methods for monitoring the pressure of vehicle tires are known from modern vehicles or from the literature. When pressures are monitored, a tire inflation pressure is determined and compared with a stored set point value. Based on the comparison result it is determined whether or not the vehicle tire has an incorrect tire pressure.

For example, German patent document DE 101 30 640 A1 discloses a method and apparatus for monitoring tire pressures in a motor vehicle, in which at least one tire pressure minimum limiting value based on a set point value for the tire pressure is adjusted and correspondingly adapted as a function of current measured tire pressures. The described method provides two different adaptable tire pressure minimum limiting values in order to warn the driver when there is a small pressure loss and to issue an alarm to him when there is a high pressure loss. In addition, the tire pressure minimum limiting values are adapted as a function of measured temperature values.

In German patent document DE 102 37 699 A1 a device for electronic tire pressure monitoring includes a wheel electronic system which determines the actual pressure and the actual temperature in a vehicle tire, a central control device, an output unit for representing the actual pressures (which are standardized to a reference temperature with predefinable set point pressures) and an inflation display for representing information relating to the inflation of a vehicle tire as a function of the recorded actual pressures. The set point pressures which are set at the reference temperature are converted by the control device to set point pressures at the current actual temperature of the vehicle tires and are displayed on the inflation display. If a “soft warning message” is present, the driver is requested to check the tire pressure by a corresponding representation of information on the output unit. The “soft warning message” is output, for example, at an excessively low tire pressure which still ensures safe driving, with the driver not being requested to correct the tire pressure until the next time the ignition is switched on. If a “hard warning message” is present, driving safety is no longer ensured and the warning message is output immediately.

One object of the present invention is to provide a tire pressure monitoring method which reliably and promptly informs the driver about a drop in the tire pressure.

Another object of the invention is to provide an associated device for monitoring the pressure of vehicle tires.

These and other objects and advantages are achieved by the tire pressure monitoring according to the invention, in which, when the activation conditions are met, a first warning message is not output until after the ignition has been switched off for a predefinable time period. The first warning message is activated if a determined incorrect tire pressure reaches or exceeds a predefined first threshold value (i.e., if a pressure loss which is calculated from the difference between the acquired tire pressure value and a stored set point value reaches or exceeds the first threshold value).

The first warning message advantageously corresponds to what is referred to as a “soft warning” which indicates to a user that he should correct the tire pressure. The purpose of the “soft warning” is not to alert the driver to an acutely hazardous situation but rather to remind him in good time that the tire pressures have gradually dropped and should be corrected when there is an opportunity to do so. The vehicle is therefore still in a roadworthy state. The outputting of the “soft warning” when the ignition is switched off has the advantage that, for example, the driver is reminded that the tire pressure has dropped before he gets out of the vehicle when refueling, and he can then also correct the tire pressure after the refueling process.

As a result, acceptance of the warning message by the user is increased. If the driver were not to be reminded that the tire pressure has dropped until, for example, the ignition is switched on again, he would have to get out of the vehicle again to correct the tire pressure. In addition, the first warning message would be output even if the driver had corrected the tire pressure between the switching off of the ignition and the switching on of the ignition.

If the driver reacts to the first warning message and sets the tire pressures on the vehicle correctly, what is referred to as a “hard warning message” will be output only if there is actually a problem with the tires. If, for example, a nail has punctured the tire or if there is some other acute leak present, the “hard warning message” appears during the journey, for example in the form of a visual and an acoustic output. However, by virtue of the method according to the invention the unsettling “hard warning message” is advantageously not displayed when there is a general loss of pressure caused by diffusion.

In one refinement of the method according to the invention, the first warning message is activated if the conditions for activation of the first warning message are detected repeatedly or over a predefinable time period. This advantageously ensures that the first warning message is not activated in error, for example as a result of an incorrect measurement.

In a further refinement of the method according to the invention, the first warning message is deactivated again, and as a result the first warning message is prevented from being output, if the incorrect tire pressure which is determined drops below the predefined first threshold value again. This may occur, for example, if the tire pressure is increased when the ignition is switched on.

In addition, the first warning message can be deactivated so that it can be prevented from being output if, for example, inflation of the respective tire or manual re-activation is detected (triggered, for example, by activation of a manual activation means as part of an operator control menu). The re-activation clears a currently valid warning messages.

In a further refinement of the method according to the invention, a second warning message (i.e., a “hard warning message”) is activated and output if the incorrect tire pressure which is determined reaches or exceeds a predefined second threshold value. The second warning message is output immediately after the activation conditions have been met, and indicates an unroadworthy state of the vehicle. The second warning message deactivates the first warning message, preventing it from being output.

In a further embodiment of the method according to the invention for monitoring the pressure of vehicle tires, a tire temperature value is determined and is used to determine the tire pressure values.

In a further embodiment of the method according to the invention for monitoring the pressure of vehicle tires, when the tire pressure values are determined the influence of temperature is compensated.

A device for monitoring vehicle tire pressure, in particular for carrying out the method according to the invention, comprises at least one tire sensor unit which, for an associated tire, determines a tire inflation pressure value and transmits it to an evaluation and control unit. The evaluation and control unit compares the acquired tire pressure value with at least one stored set point value and, based on the comparison result, determines whether the vehicle tire has an incorrect tire pressure, in particular an excessively low tire pressure. The evaluation and control unit outputs the first warning message via an output unit if the determined incorrect tire pressure reaches or exceeds a predefined first threshold value. According to the invention, when the activation conditions are met, the evaluation and control unit does not output the first warning message via the output unit until after the ignition has been switched off for a predefinable time period.

In a further embodiment of the tire pressure monitoring device according to the invention, the evaluation and control unit outputs the second warning message via the output unit if the determined incorrect tire pressure reaches or exceeds a predefined second threshold value. The evaluation and control unit deactivates the first warning message, so that the latter cannot be output, if the second warning message is activated.

In a further refinement of the device according to the invention for monitoring the pressure of vehicle tires, the at least one tire sensor unit determines the temperature in the associated tire and transmits the temperature signal to the evaluation and control unit, which takes into account the tire temperature in the determination of the tire pressure values.

Other objects, advantages and novel features of the present invention will become apparent from the following detailed description of the invention when considered in conjunction with the accompanying drawings.

### BRIEF DESCRIPTION OF THE DRAWINGS

FIG. 1 is a block diagram of a device for monitoring the pressure of vehicle tires;

FIG. 2 is a flowchart which shows the steps of a method for monitoring the pressure of vehicle tires; and

FIG. 3 is a schematic illustration of warning thresholds.

### DETAILED DESCRIPTION OF THE DRAWINGS

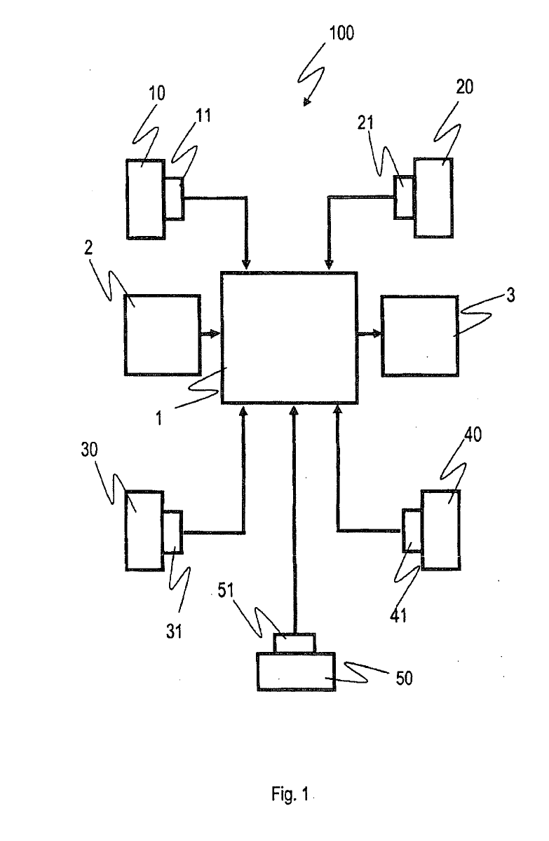

As shown in FIG. 1, the device 100 for monitoring the pressure of vehicle tires comprises, for each tire 10, 20, 30, 40, 50, a tire sensor unit 11, 21, 31, 41, 51 which, for the associated tire, determines a tire inflation pressure and a tire temperature. The tire sensor units 11, 21, 31, 41, 51 transmit the determined values (for example via wire-free transmission) to an evaluation and control unit 1 which compares the acquired tire pressure value with at least one stored set point value. Based on the comparison result, it then determines whether one of the vehicle tires 10, 20, 30, 40, 50 has an incorrect tire pressure, in particular an excessively low tire pressure. In the exemplary embodiment illustrated, the evaluation and control unit 1 takes into account the tire temperature in the determination of the tire pressure values and compensates for the influence of temperature.

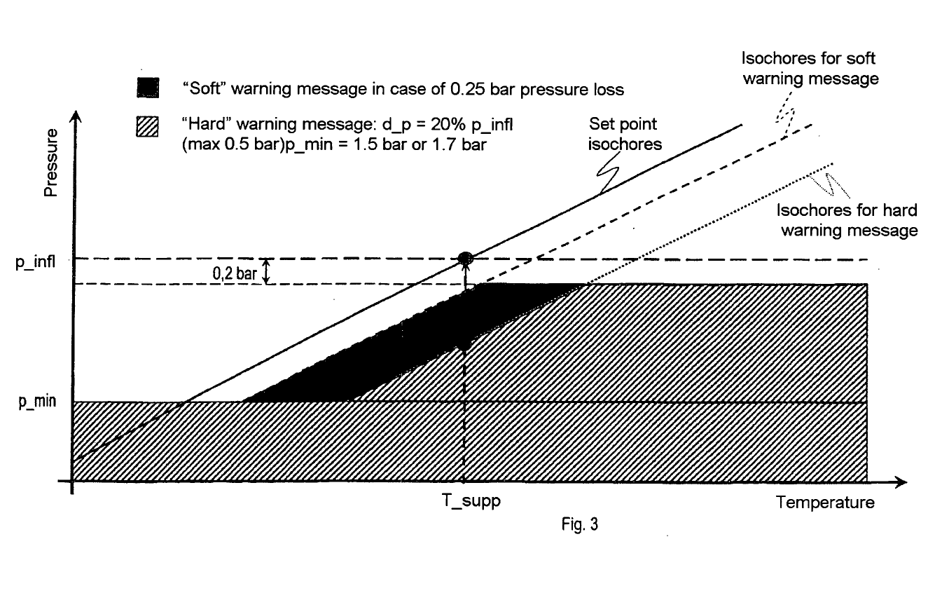

FIG. 3 shows a diagram of the characteristic curves used for temperature compensation. The evaluation and control unit 1 outputs a first warning message via an output unit 3 if a determined improper tire pressure reaches or exceeds a predefined first threshold value. (The first threshold value corresponds here, for example, to a pressure loss of more than 0.25 bar.) When the activation conditions are met, the evaluation and control unit 1 does not output the first warning message until after the ignition has been switched off for a predefinable time period, for example for 30 seconds. The first warning message corresponds, for example, to a “soft warning message” which indicates to the user that the tire pressure has dropped and should be corrected. Such a first warning message is output, for example, as a visual display via the output unit 3.

The evaluation and control unit 1 outputs a second warning message via the output unit 3 if the determined incorrect tire pressure reaches or exceeds a predefined second threshold value. The second threshold value corresponds, for example, to a pressure loss of more than 0.5 bar. The evaluation and control unit 1 deactivates the first warning message, preventing it from being output, if the second warning message is activated. The second warning message corresponds, for example, to a “hard warning message” which indicates to the user that the tire pressure has dropped dramatically, and that the vehicle is in an unroadworthy state. The second warning message may be output for example as a combined visual and audible display via the output unit 3 immediately after the activation conditions are met.

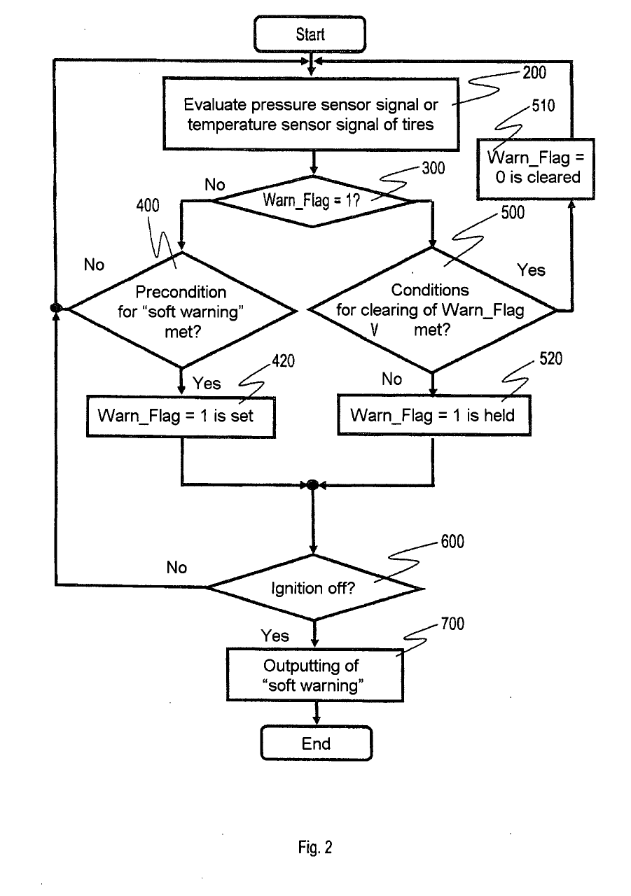

As is apparent from FIG. 2, the method according to the invention for monitoring the pressure of vehicle tires after the start in step 200 evaluates the signals of the tire sensor units 11, 21, 31, 41, 51. In particular, the pressure sensor signal and the temperature sensor signal are evaluated in order to determine the tire pressure value. In step 300 it is checked whether the “soft warning message” is activated (i.e., whether or not a warning flag signal Warn_Flag is set to a high logic level).

If the warning flag signal Warn_Flag is not set, in step 400 it is checked whether the preconditions for activating the “soft warning message” are met. In order to check the preconditions, for example the tire pressure value which is determined for each tire is compared with at least one stored set point value. If the tire pressure values which are determined for all the tires 10, 20, 30, 40, 50 lie within a predefined range, the soft warning message is not activated and the method returns to the starting point.

However, if at least one of the checked tires 10, 20, 30, 40, 50 has, for a predefinable number of checks or for a predefinable time period, for example 12 minutes, an excessively low pressure which is higher than or equal to a predefined first threshold value, the “first warning message” is activated. The first warning message can be activated, for example, on a position-related basis (i.e., individually for each tire or without a position reference). The activation of the “soft warning message” is carried out, for example, by setting the warning flag signal Warn_Flag to a high logic level in step 420.

In the illustrated exemplary embodiment, a pressure loss of 0.25 bar at a temperature T_supp of, for example, 20° C. is predefined as a first set point value for the “soft warning message”. FIG. 3 shows a schematic illustration of a set point isochore and of isochores for the “soft warning message” and for the “hard warning message” which are used for temperature compensation of the tire pressure values and of the warning thresholds for the “soft warning message” and for the “hard warning message”. The warning threshold for the “soft warning message” is limited in the upward direction by the difference between the tire pressure value p_infl−0.2 bar and in the downward direction by the tire-specific minimum pressure.

If in step 300 it is determined that the warning flag signal Warn_Flag is set, in step 500 it is checked whether at least one condition for deactivating the first warning message (i.e., for clearing the warning flag signal Warn_Flag) is met. A condition for clearing the warning flag signal Warn_Flag is apparent if the determined incorrect tire pressure drops below the predefined first threshold value again or if inflation of the respective tire 10, 20, 30, 40, 50 or manual re-activation of the system is detected. The re-activation is triggered, for example, by activation of a manual activation means 2 as part of an operator control menu. Re-activation causes the first warning message which is currently valid to be deactivated. In addition, the warning flag signal Warn_Flag can be cleared (and the “soft warning message” deactivated) if the determined incorrect tire pressure reaches or exceeds a predefined second threshold value and the second warning message is activated and output via the output unit 3. If such a condition is detected, in step 510 the warning flag signal Warn_Flag is cleared to a low logic level and the method returns to the starting point.

If in step 500 no condition is detected for clearing the warning flag signal Warn_Flag, the warning flag signal Warn_Flag is held in the set state (i.e., at the high logic level, in step 520).

In step 600 it is checked whether the vehicle's ignition has been switched off If the vehicle's ignition has not been switched off, the method returns to the starting point. If the ignition has been switched off, in step 700 the “soft warning message” is output as a visual output by the output unit 3 after the ignition has been switched off for a predefined time period, for example 30 seconds. The “soft warning message” can be output in a position-related fashion for at least one tire whose inflation pressure is to be increased or is output as a general request to check the tire inflation pressure without a position reference. Therefore, when the activation conditions are met the first warning message is not output until after the ignition has been switched off for a predefinable time period, so that before the driver gets out of the vehicle he is advantageously provided with the information that the tire pressure should be checked.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1.-10. (canceled)

11. A method for monitoring vehicle tire pressure in which a tire inflation pressure is acquired and compared with at least one stored set point value, and based on a result of the comparison, it is determined whether the vehicle tire has an incorrect tire pressure, wherein:
a first warning message is output if the determined incorrect tire pressure reaches or exceeds a predefined first threshold value; and
output of the first warning message is delayed until after the ignition has been switched off for a predefinable time period.

12. The method as claimed in claim 11, wherein the first warning message is activated if conditions for activation of the first warning message are detected over a relatively long predefinable time period.

13. The method as claimed in claim 11, wherein the first warning message is deactivated again, and as a result the first warning message is thereby prevented from being output, if the incorrect tire pressure which is determined returns to a level that is below the predefined first threshold.

14. The method as claimed in claim 11, wherein the first warning message is deactivated, and is thereby prevented from being output, if inflation of a respective tire or manual re-activation is detected.

15. The method as claimed in claim 11, wherein, if the incorrect tire pressure reaches or exceeds a predefined second threshold value:
a second warning message is activated and output; and
the first warning message is deactivated so that it is prevented from being output.

16. The method as claimed in claim 11, wherein a tire temperature value is determined and is used to determine the tire pressure values.

17. The method as claimed in claim 16, wherein, when the tire pressure values are determined, the temperature influence is compensated.

18. A device for monitoring vehicle tire pressure, comprising:
an evaluation and control unit;
at least one tire sensor unit which determines, for an associated tire, a tire inflation pressure value and transmits it to an evaluation and control unit; wherein,
the evaluation and control unit compares the acquired tire pressure value with at least one stored set point value and, based on a comparison result, determines whether the vehicle tire has an incorrect tire pressure;
the evaluation and control unit outputs a first warning message via an output unit if the determined incorrect tire pressure reaches or exceeds a predefined first threshold value; and
output of the first warning message via the output unit is delayed until after the ignition has been switched off for a predefinable time period.

19. The device as claimed in claim 18, wherein:
the evaluation and control unit outputs a second warning message via the output unit if the determined incorrect tire pressure reaches or exceeds a predefined second threshold value; and
the evaluation and control unit deactivates the first warning message, preventing it from being output, if the second warning message is activated.

20. The device as claimed in claim 18, wherein:
the at least one tire sensor unit determines the temperature in the associated tire and transmits it to the evaluation and control unit; the evaluation and control unit takes into account the tire temperature in the determination of the tire pressure values.
